(19) United States
(12) Patent Application Publication
(10) Pub. No.: US 2020/0140194 A1
(43) Pub. Date: May 7, 2020

(54) WASTE CONTAINMENT DEVICE

(71) Applicant: Mark D. Tyrol, Mansfield, MA (US)

(72) Inventor: Mark D. Tyrol, Mansfield, MA (US)

(21) Appl. No.: 16/460,866

(22) Filed: Jul. 2, 2019

Related U.S. Application Data
(60) Provisional application No. 62/693,822, filed on Jul. 3, 2018.

(51) Int. Cl. B65F 1/16; B65F 1/02

(52) U.S. Cl. CPC B65F 1/1607; B65F 1/02

(57) ABSTRACT

A waste containment device comprises a chamber, the chamber comprising a generally elongate shape and having a first and a second opening at opposite distal ends of the generally cylindrical chamber; a first lid, the first lid configured to be removably disposed at the first distal end of the chamber, and wherein the first lid includes a top portion which covers the first distal end and wherein the top portion includes a plurality of slits emanating from the center of the top portion toward the outer edge of the upper portion, the slits allowing access through the first lid via the upper portion into an inner portion of the chamber; a second lid, the second lid configured to be removably disposed at the second distal end.

### PRIORITY CLAIM

This application claims priority from U.S. Provisional Application No. 62/693,822 filed Jul. 3, 2018; which application is hereby incorporated by reference in its entirety as if fully set forth herein.

### RELATED APPLICATION

This application is related to co-pending Design application Ser. No. 29/656,901 filed Jul. 17, 2018; which application is hereby incorporated by reference in its entirety as if fully set forth herein.

### COPYRIGHT NOTICE

This disclosure is protected under United States and/or International Copyright Laws. © 2018-2019 Mark D. Tyrol. All Rights Reserved. A portion of the disclosure of this patent document contains material which is subject to copyright protection. The copyright owner has no objection to the facsimile reproduction by anyone of the patent document or the patent disclosure, as it appears in the Patent and/or Trademark Office patent file or records, but otherwise reserves all copyrights whatsoever.

### FIELD OF THE DISCLOSURE

The present disclosure relates to waste containment devices, and more specifically to waste containment devices to be used anywhere food or drink is served or consumed, such as restaurants, parks, other outdoor venues, seating areas, automobiles, trucks, boats golf carts, etc.

### BACKGROUND OF THE INVENTION

Management of waste, particularly in small places such as on eating tables or seating areas, automobiles, trucks, boats golf carts, etc. has previously included miniature trash cans, ash trays, trash bags and the like. Miniature trach cans have typically been viewed as unsightly, particularly when in or immediate to a place for eating. No smoking laws have removed ash trays from restaurant tabletops. In addition, ash trays do not prevent trash or other small waste from being blown away when in an outside or wind exposed location. As a result, improvements can be made to small waste receptacles, such as used in or near eating or gathering places, automobiles, trucks, boats golf carts, etc.

### SUMMARY OF THE INVENTION

A waste containment device comprises a chamber, the chamber comprising a generally cylindrical shape and having a first and a second opening at opposite distal ends of the generally cylindrical chamber; a first lid, the first lid configured to be removably disposed at the first distal end of the chamber, and wherein the first lid includes a top portion which covers the first distal end and wherein the top portion includes a plurality of slits emanating from the center of the top portion toward the outer edge of the upper portion, the slits allowing access through the first lid via the upper portion into an inner portion of the chamber; a second lid, the second lid configured to be removably disposed at the second distal end.

### BRIEF DESCRIPTION OF THE DRAWINGS

Preferred and alternative examples of the present invention are described in detail below with reference to the following drawings:

FIGS. 1A-1D illustrate multiple views of an example waste containment device, suitable, for example, as a tabletop embodiment of the present invention. The waste containment device includes a container (FIGS. 2A-2D), a flexible grommet style top lid (FIGS. 3A-3C), and a removable bottom cap (FIG. 4);

FIGS. 1E-1F illustrate multiple views of another example waste containment device suitable, for example, as a vehicle cupholder embodiment of the present invention;

FIG. 2A-2D illustrate an example a tabletop version of the waste containment device;

FIG. 3A-3C illustrate an example flexible grommet style top lid that may be removably attached or permanently attached to the top of the waste containment container of FIGS. 2A-2D;

FIG. 4 illustrates example bottom caps that may be removably attached to the bottom of the waste containment container of FIGS. 2A-2D and FIGS. 5A-5D. A non-slip pad may be provided on the bottom lid;

FIGS. 5A-5D illustrate multiple views of another example waste containment device container in accordance with an embodiment of the present invention. The waste containment device includes a container (FIGS. 5A-5D), a removable top lid (FIG. 6A), and a removable bottom cap (FIG. 4);

FIG. 6A illustrates example top lids that may be removably attached to the waste containment device container of FIGS. 5A-5D;

FIG. 6B illustrates example openings that may be formed or cut into the top lids of FIG. 6A;

FIGS. 7A-7D illustrate multiple views of yet another example waste containment device container in accordance with an embodiment of the present invention;

FIGS. 8A-8D illustrate an example top lid that may be removably attached to the waste containment device of FIGS. 7A-7D; and,

FIGS. 9A-9C illustrate an example bottom cap that may be removably attached to the bottom of the waste containment device of FIGS. 7A-7D.

### DETAILED DESCRIPTION OF THE PREFERRED EMBODIMENT

Described herein is a trash receptacle with a partially open and optionally removable, lid. In some cases, the receptacle, bin, or device may be particularly suited for placement on a table, for collection of waste wrappers, etc. In some aspects, the device may be particularly useful anywhere food or drink is served or consumed, restaurants, parks, other outdoor venues, seating areas, etc. In other cases, the trash receptacle may be particularly suited for placement into a vehicle cup holder, for collection of waste wrappers, etc. In some aspects, the device may be particularly useful for auto, car, truck, boat, golf cart, etc.

The lid opening may have flexible flaps that allows small waste to be inserted in and through the lid, but helps retain the small waste in the container and does not allow the small waste to blow out of the container due to wind. Alternately the lid opening may be a rigid cap with an opening that is round, flower-shaped, or have another shape. The described device may be designed to facilitate depositing unsightly trash, including straws, crackers, crumbs, waste wrappers, napkins, etc. In this way, the described device may help keep tabletops, seating areas, and surrounding areas clean. The described device may additionally reduce pollution, unsightly trash and keep the surrounding environment clean.

The device may have a removable bottom. In some aspects, the receptacle or container, and/or lid and bottom may be made of plastic or other suitable material, such as blow molded or injection molded plastic. In some aspects, the bottom may be weighted, to help stabilize the container or receptacle. Additionally or alternatively, the bottom may be weighted and include slip resistant pad (positioned on the downward facing surface of the bottom) to prevent tip over. One or both of the lid and bottom may be removable to enable easier cleaning of the device. In some cases, the top opening is designed to permit entry of paper and plastic wrappers, but shaped in such a way as to discourage depositing food waste and other garbage. The device may be designed so that it fits into a vehicle cup holder or minimizes tabletop space and provides a highly visible space for decorative, advertising logos, etc.

In some aspects, custom decorations (silkscreen, sticker, laser engraving, etc.) may be included or attached to the exterior of the device. The device may include custom colors and/or printed color logos, to enable various branding opportunities. In some aspects, the device may be dishwasher safe and made of low cost materials.

In one example the described device may be referred to as a Wrap'R-Grab'R® waste containment device, and may be portable. It may be designed to keeps trash from blowing off tabletops, takes up less space than trash receptacles known in the art, and can be customized to a customer's liking (custom colors and branding). A small opening on top of container and larger body size allows the trash to enter container and not be visible. The small opening may discourage the deposit of larger garbage or food waste.

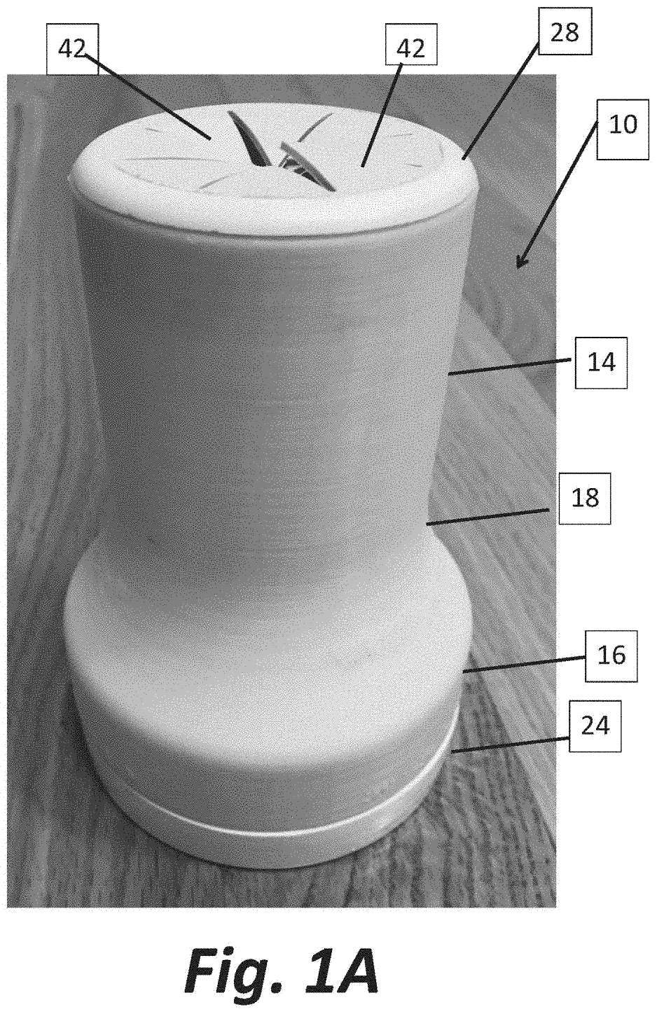

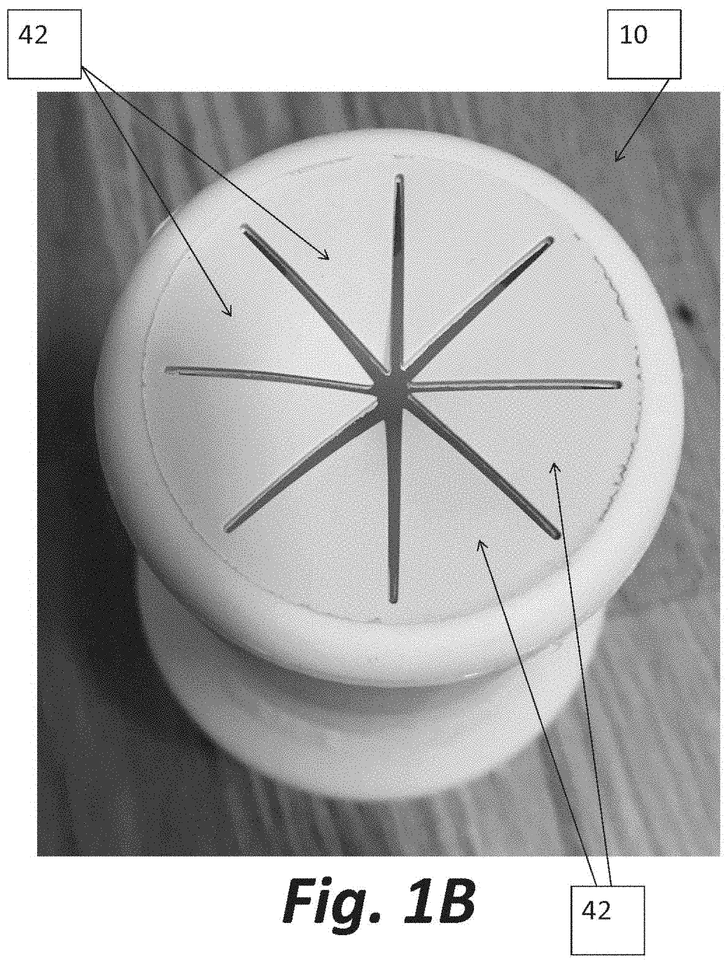

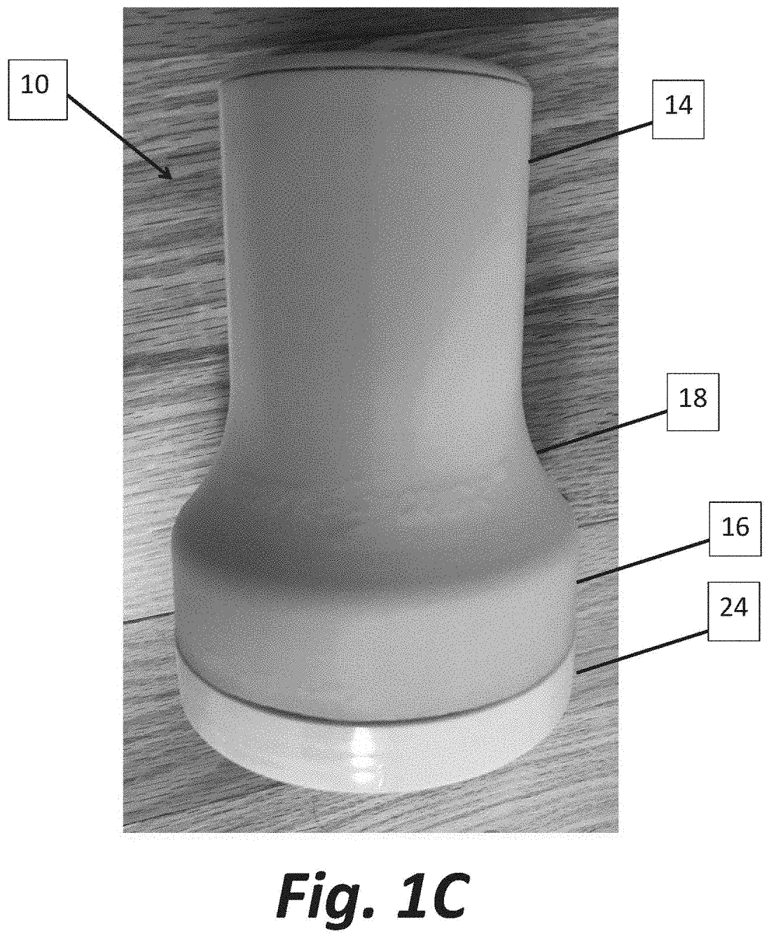

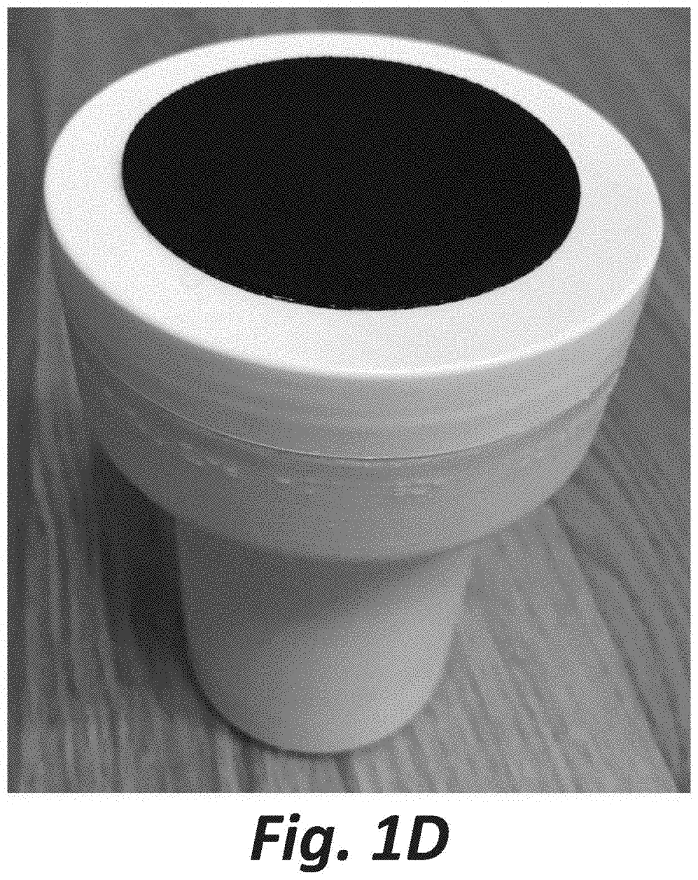

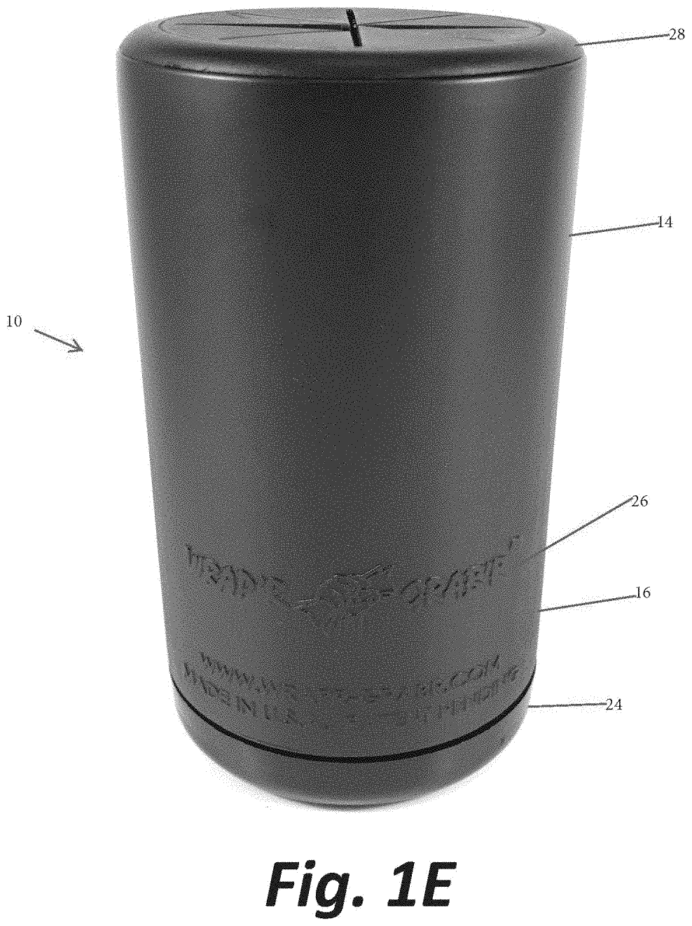

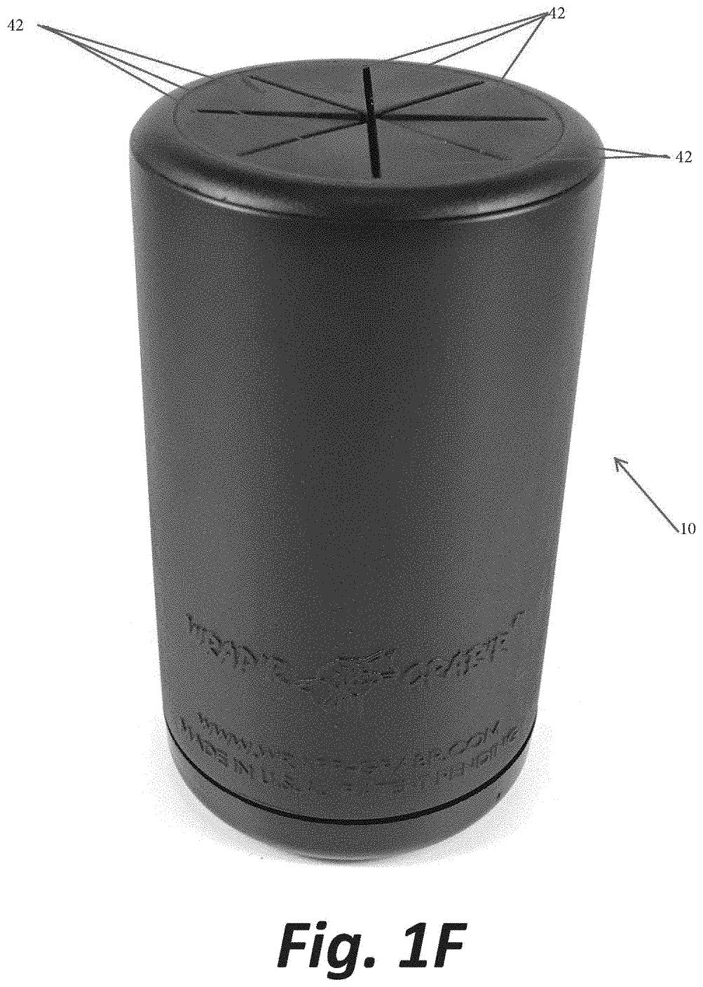

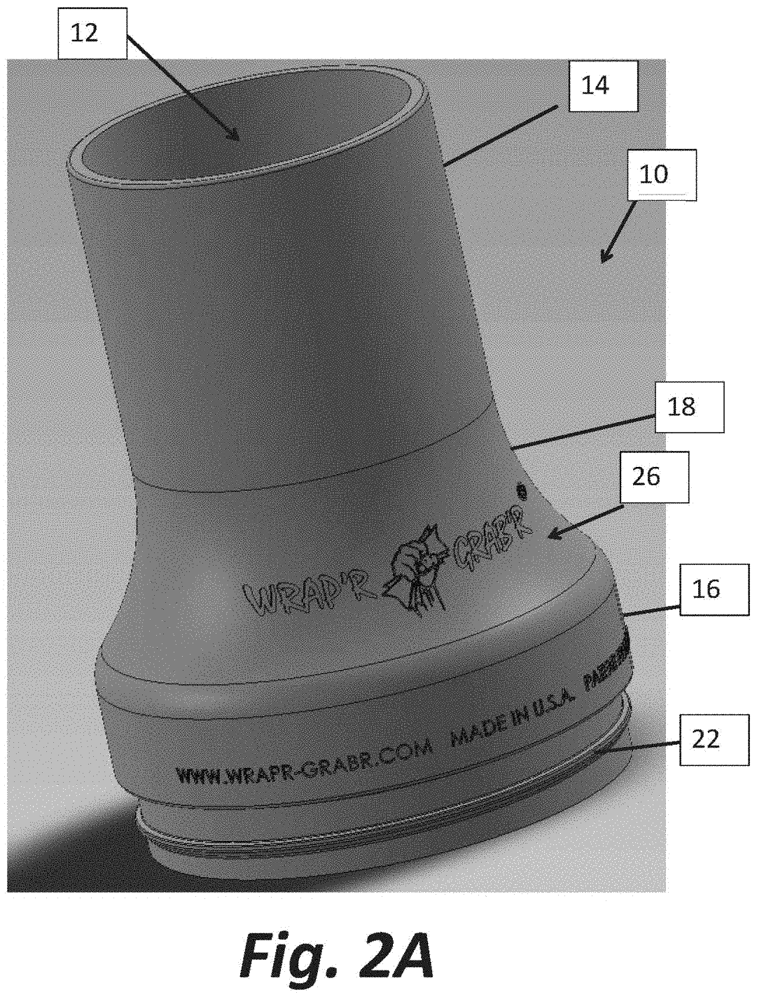

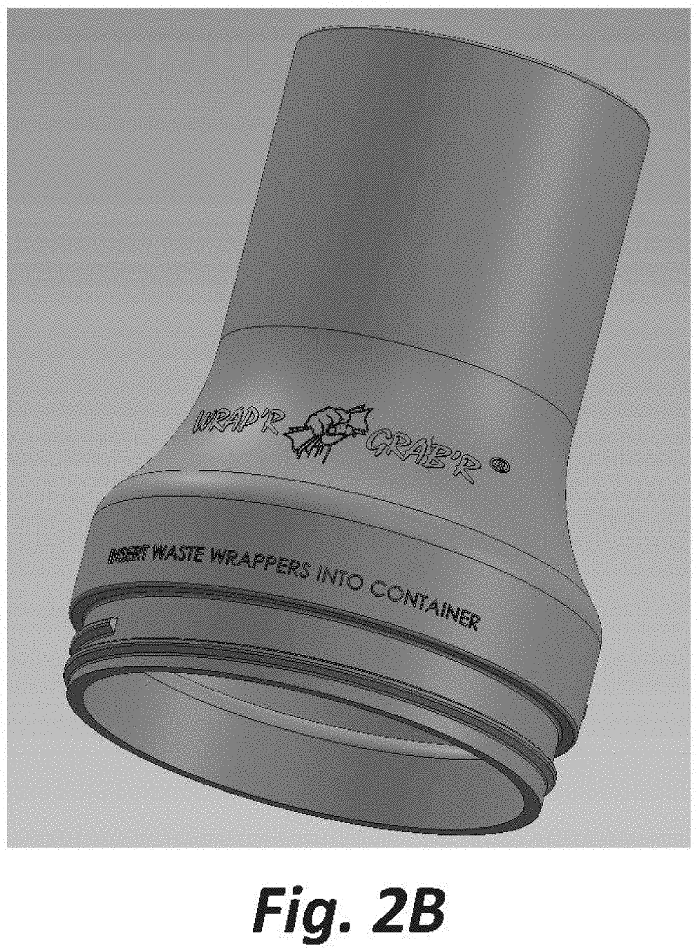

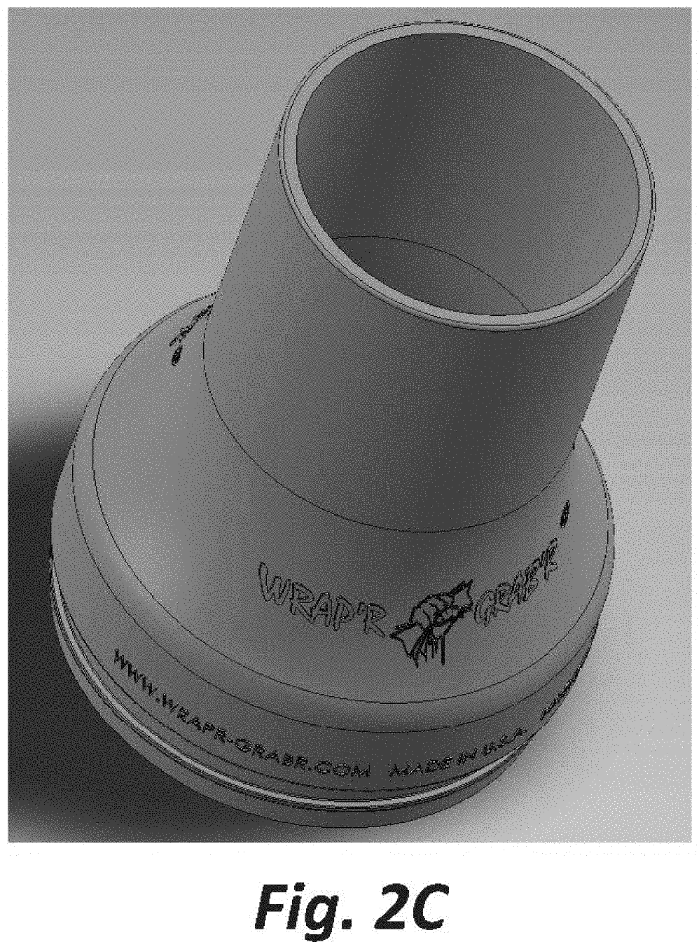

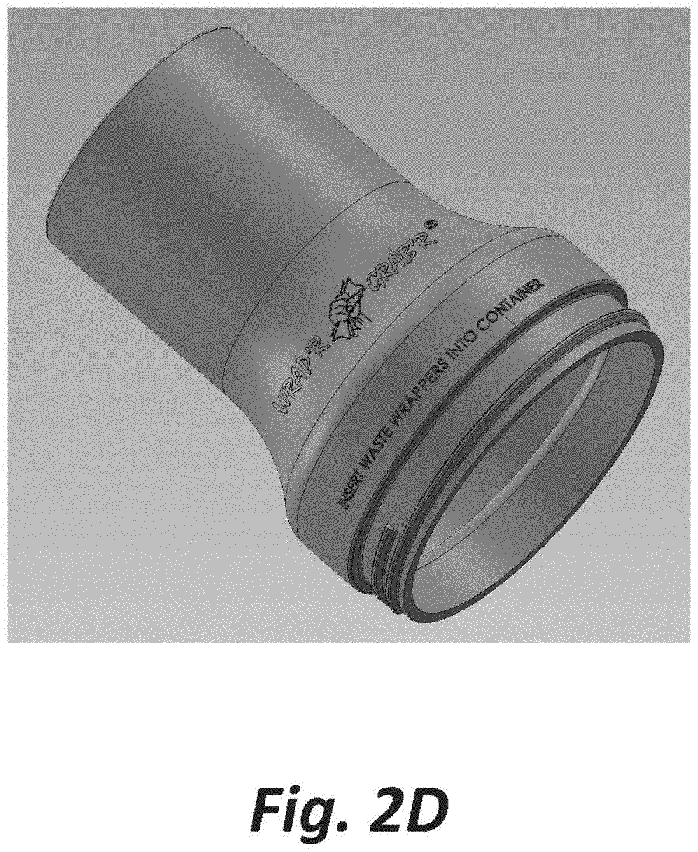

FIGS. 1A-1F illustrates multiple views of an example waste containment device 10, as described herein. FIGS. 2A-2D illustrate an embodiment of containment device 10 having a cylindrical hollow container 12 having at least two external diameters 14, 16, preferably with a flanged section 18 smoothly formed between the two diameters 14, 16. As will be discussed below, such an embodiment of device 10 as depicted in FIGS. 2A-2D is well suited for tabletop applications. Alternatively, as depicted in FIGS. 1E and 1F, the containment device 10 may have the at least two external diameters 14, 16 tapering smoothly between the two diameters 14, 16. Such an embodiment of device 10 as depicted in FIGS. 1E-1F is suitable for use with cupholders in vehicles, for example. The device may have the appropriate inside diameter or for accepting a top grommet portion 20. The device may have external screw threads 22 at the bottom for accepting a bottom portion 24. The device 10 may be formed such that it includes a face 26 for displaying logos, names, etc., which may be customizable for different needs, customers, etc.

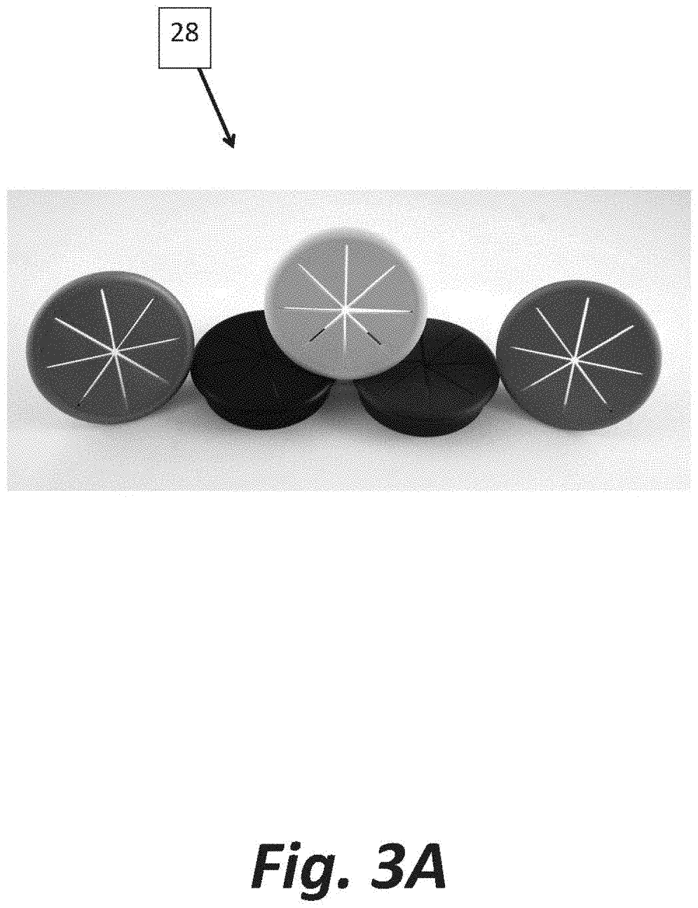

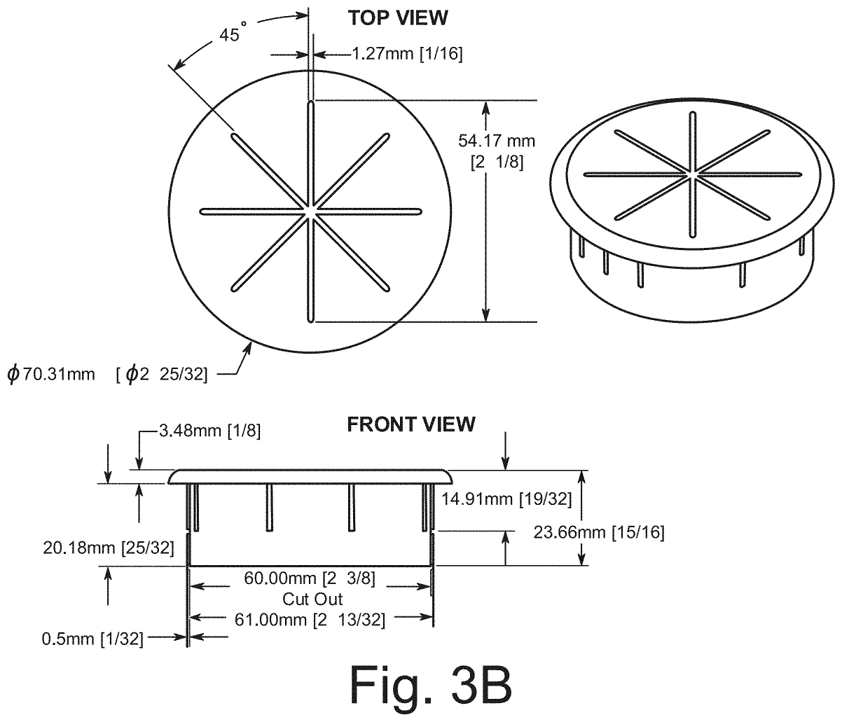

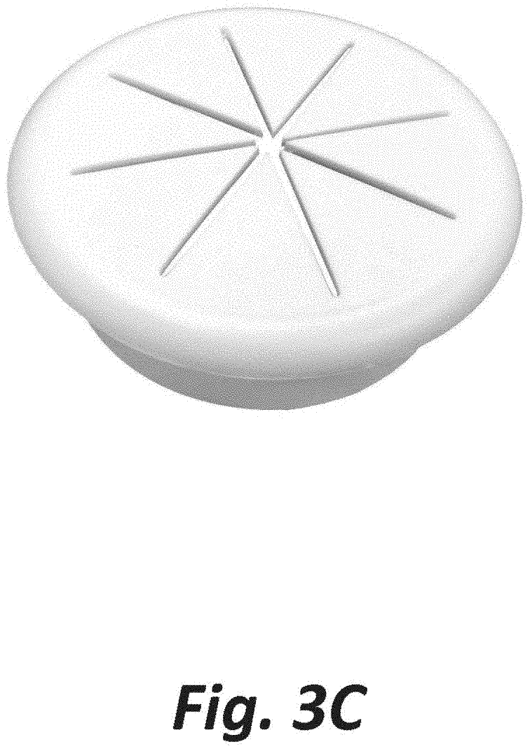

FIGS. 3A-3C illustrates an example flexible grommet style top lids 28 that may be removably attached or permanently attached to the top of the waste containment device container 10 of FIGS. 2A-2D. The example grommet style top lids 28 are friction fit into and/or glued to top of the waste containment device container 10 of FIGS. 2A-2D.

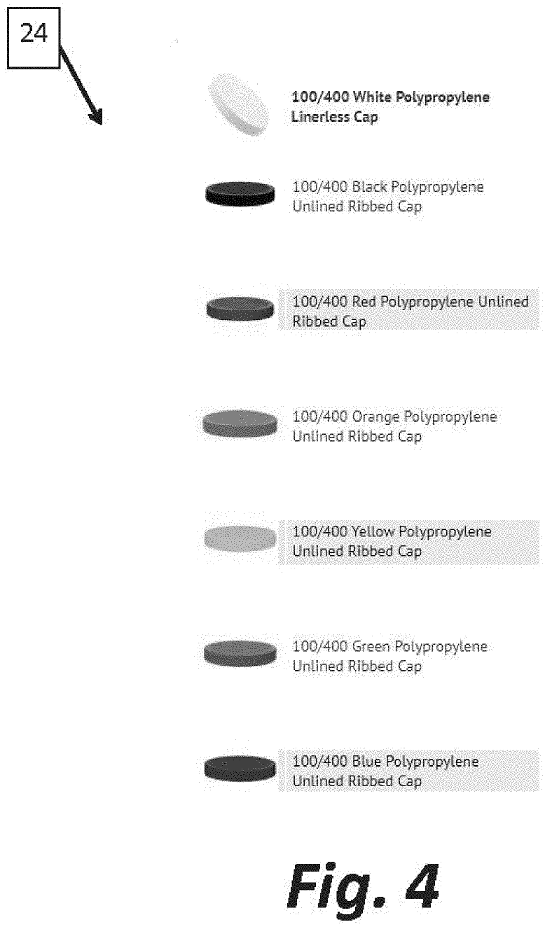

FIG. 4 illustrates example bottom caps 24 that may be removably attached to the bottom of the waste containment device container 10 of FIGS. 2A-2D. The bottom cap 24 may have internal threads for engaging the external thread 22 on the bottom of the container 10 described above in reference to FIGS. 2A-2D. The bottom cap 24 may enclose the bottom of the device 10, for retaining waste in the device.

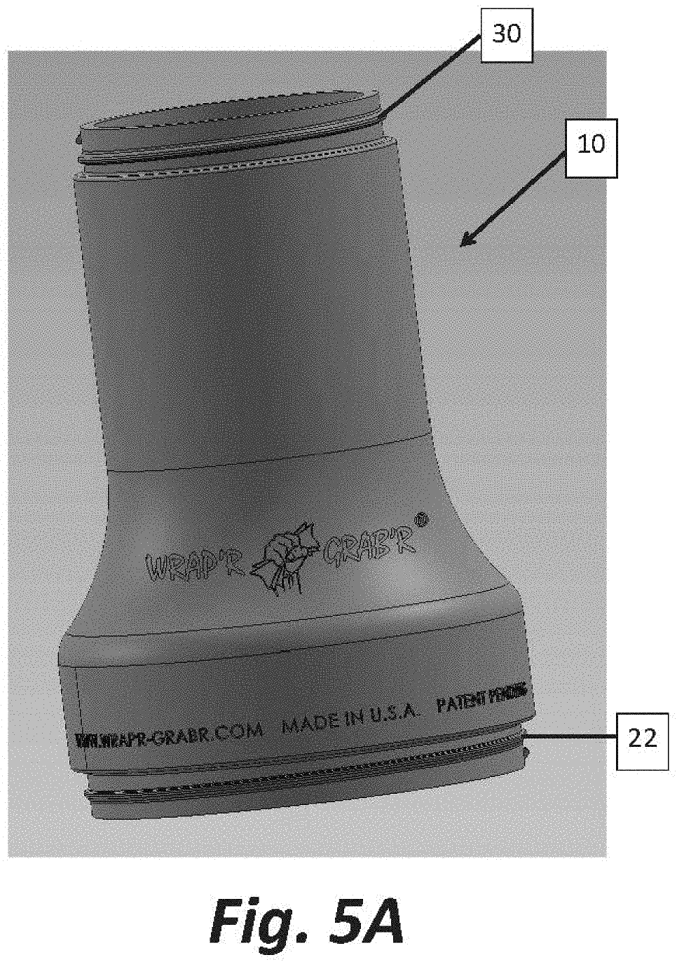

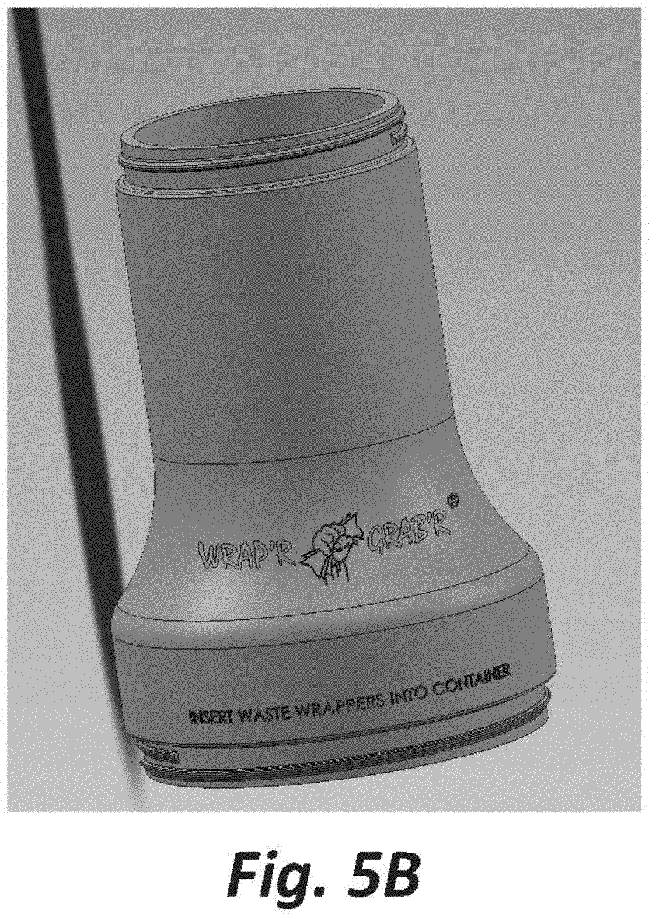

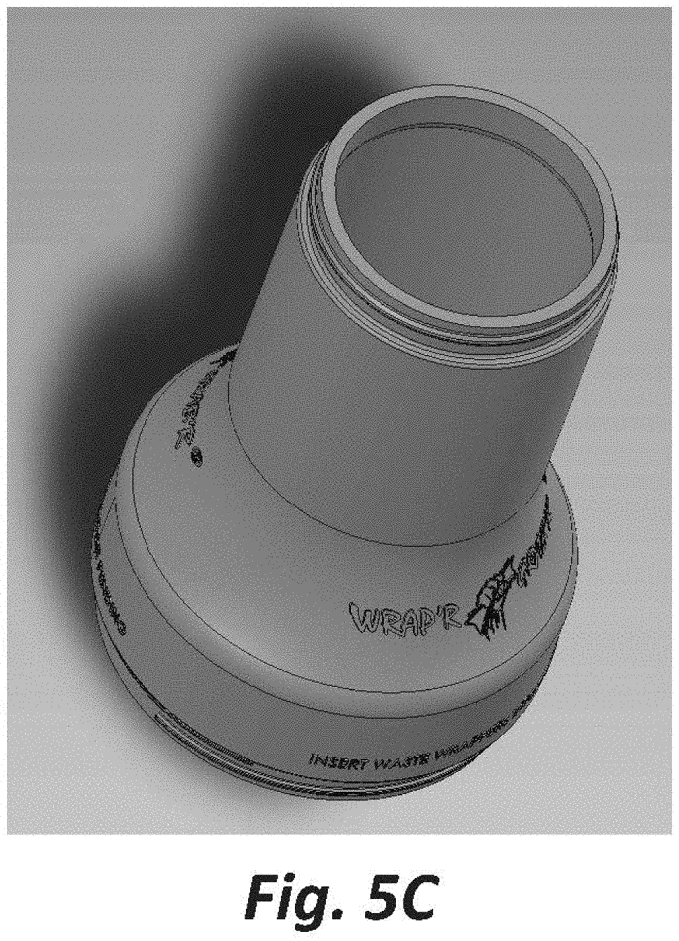

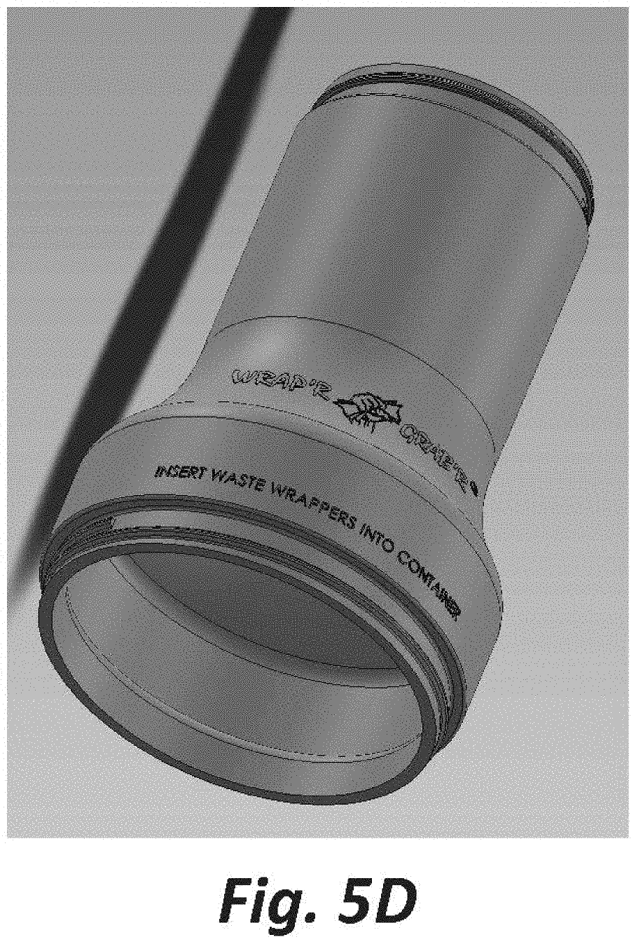

FIGS. 5A-5D illustrates multiple views of a second example waste containment device container 10. This device 10 may have external threads 30, 22, at its top and bottom portions respectively, for receiving a lid portion 28 and a bottom portion 24.

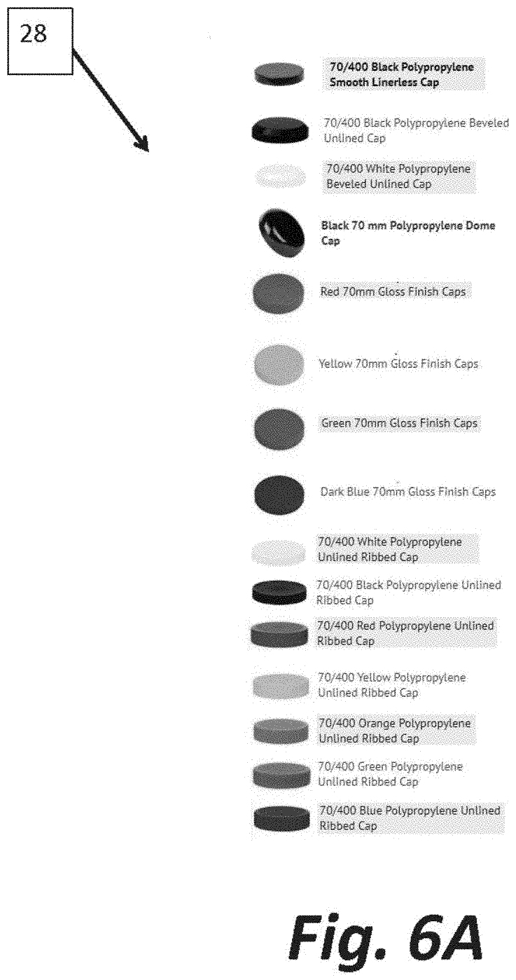

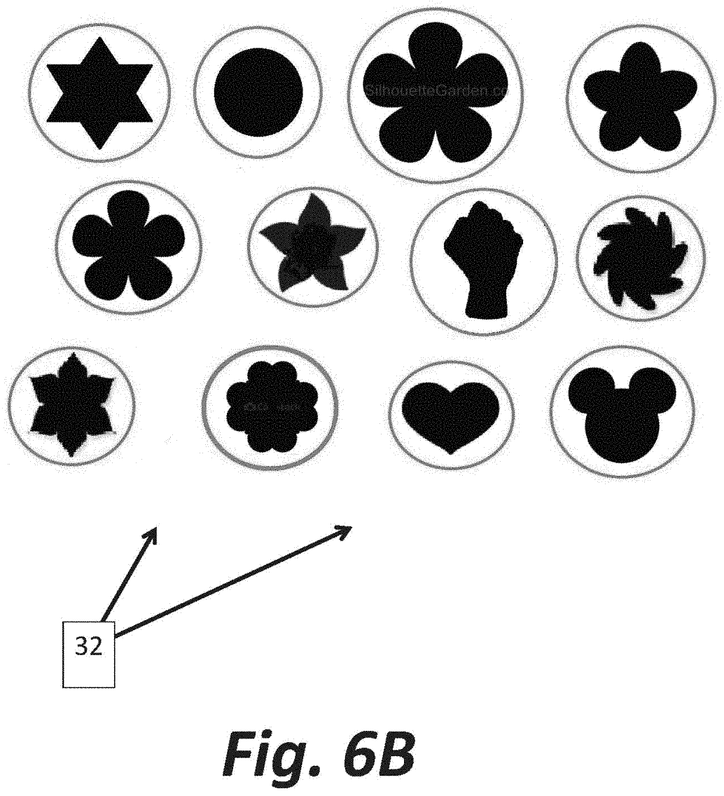

FIG. 6A illustrates example top lids 28 that may be removably attached to the waste containment device container 10 of FIGS. 5A-5D.

FIG. 6B illustrates example openings 32 that may be formed or cut into the top lids 28 of FIG. 6A. It should be appreciated that the flowers and other shape of the openings 32 illustrated in FIG. 6B are only given by way of example. Other shapes that reduce the size of the opening through the top lid in FIG. 6A are also contemplated herein.

FIG. 4 illustrates example bottom caps 24 that may be removably attached to the bottom of the waste containment device container of FIGS. 5A-5D. The bottom cap 24 may have internal threads (not shown) for engaging the external thread 22 on the bottom of the device 10 describe above in reference to FIGS. 5A-5D. The bottom cap 24 may enclose the bottom of the device 10, for retaining waste in the device.

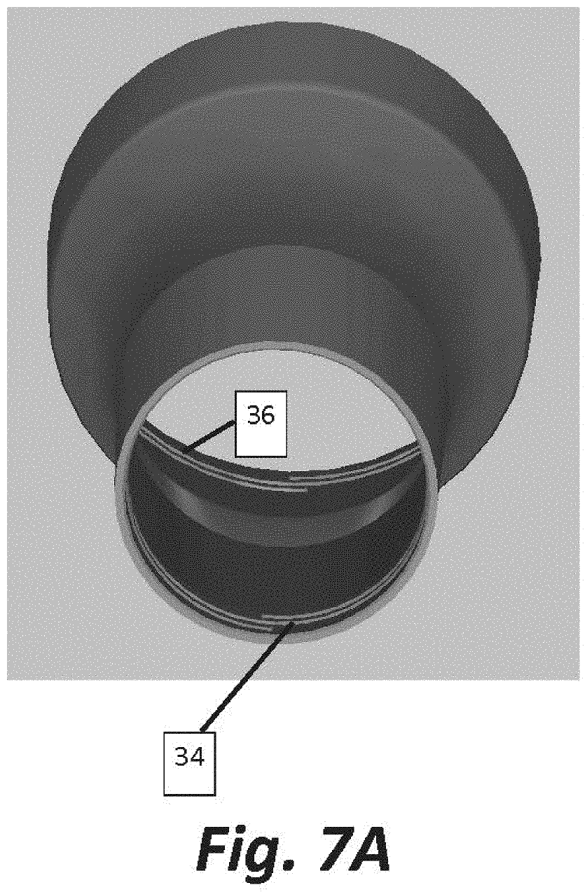

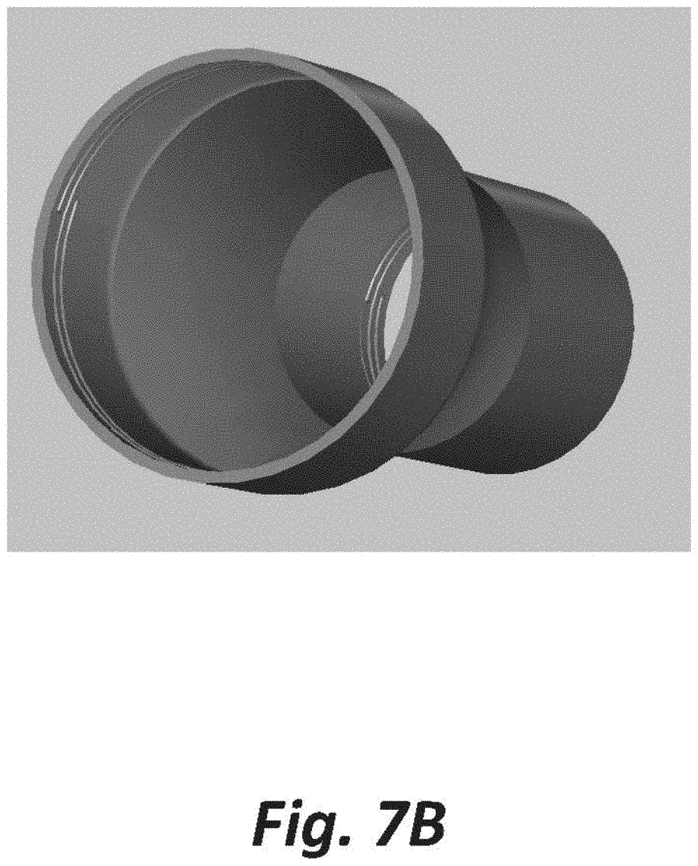

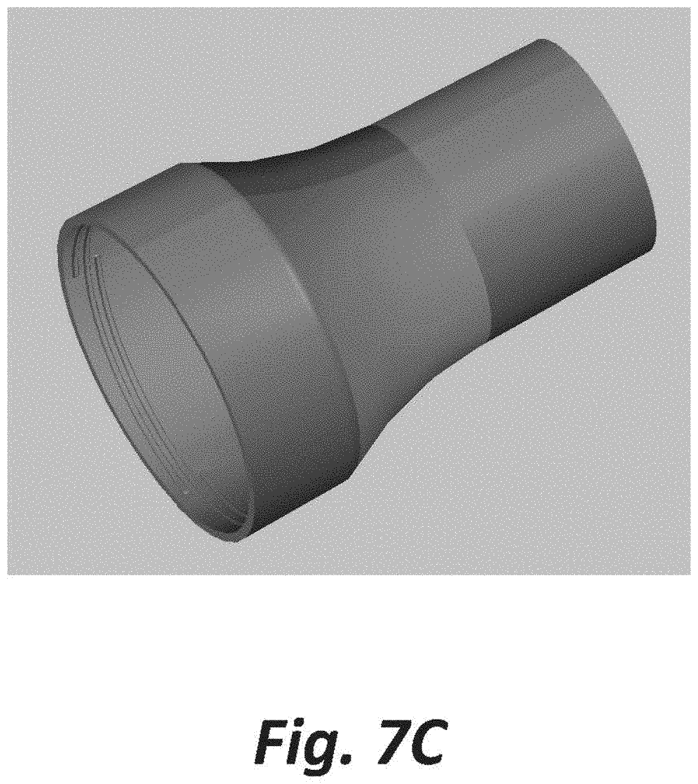

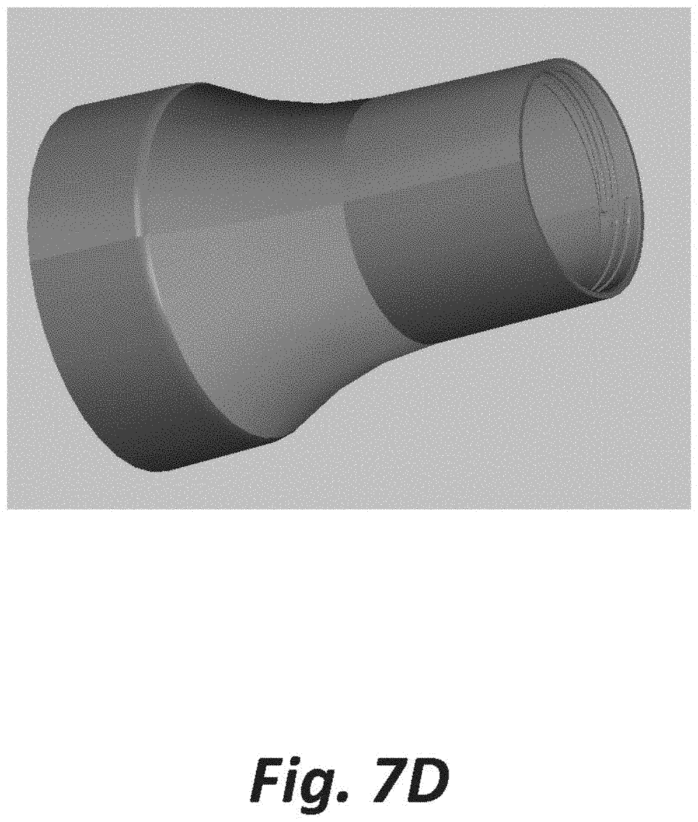

FIGS. 7A-7D illustrates multiple views of a third example waste containment device container. This device may have internal threads 34, 36, at its top and bottom portions respectively, for receiving a lid portion and a bottom portion.

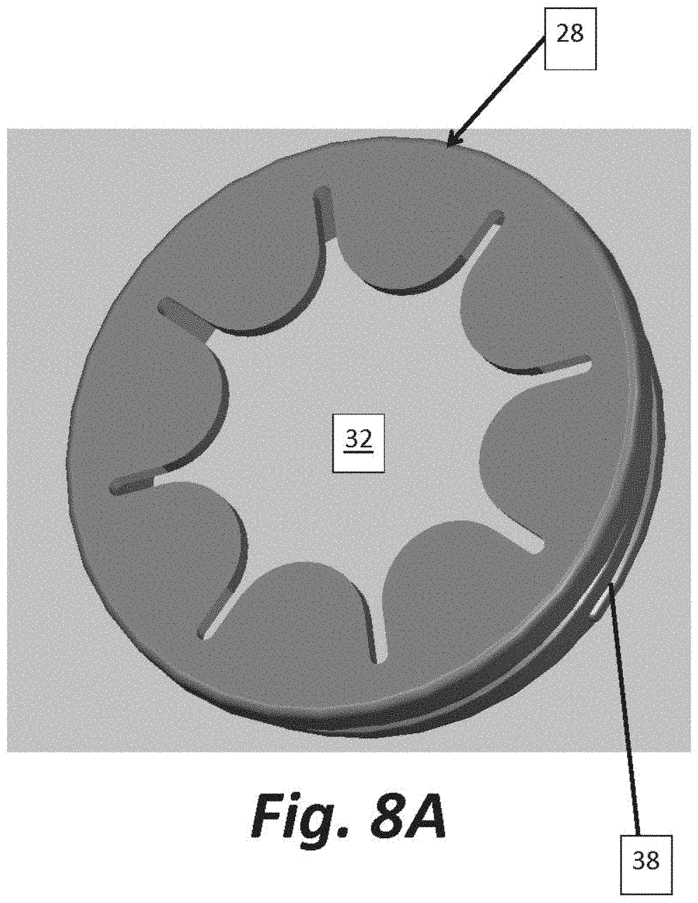

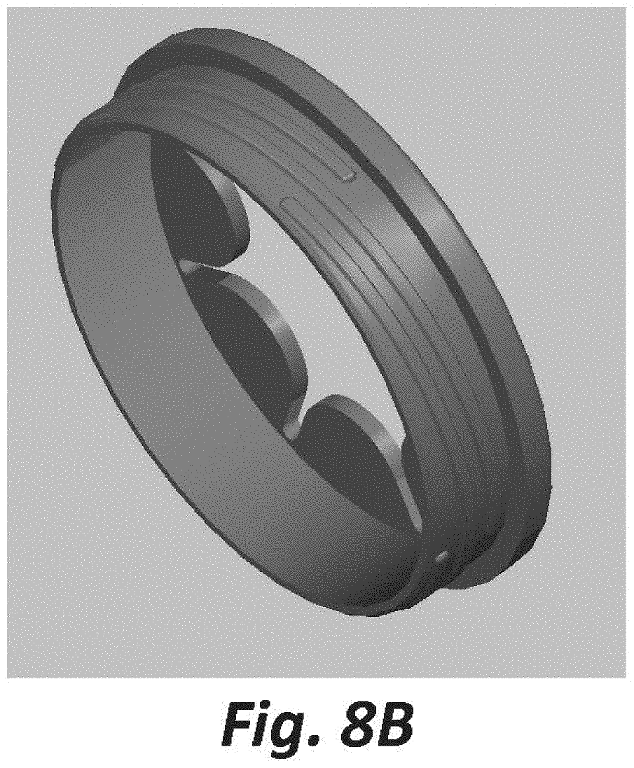

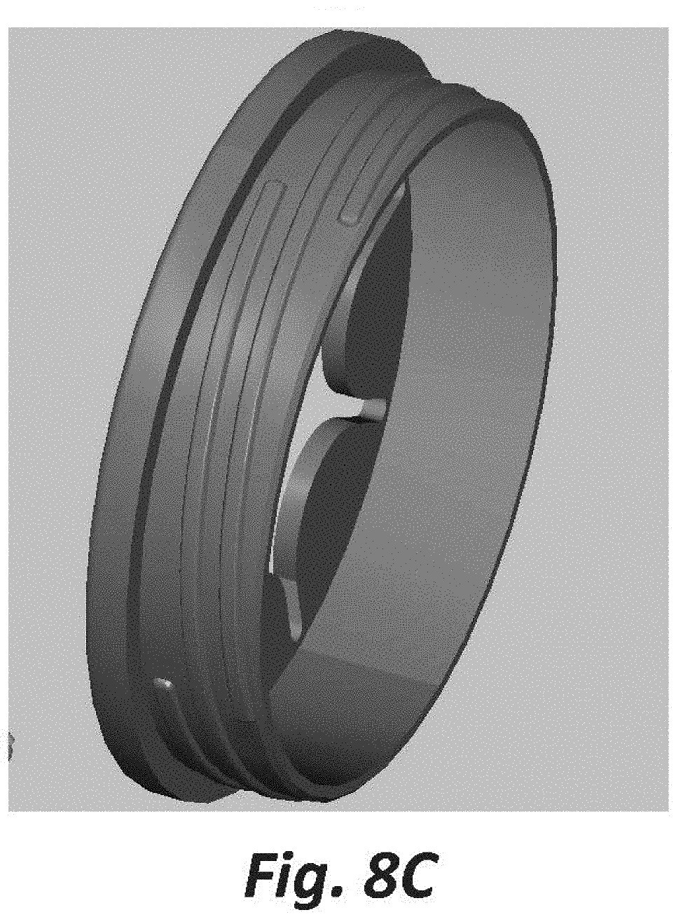

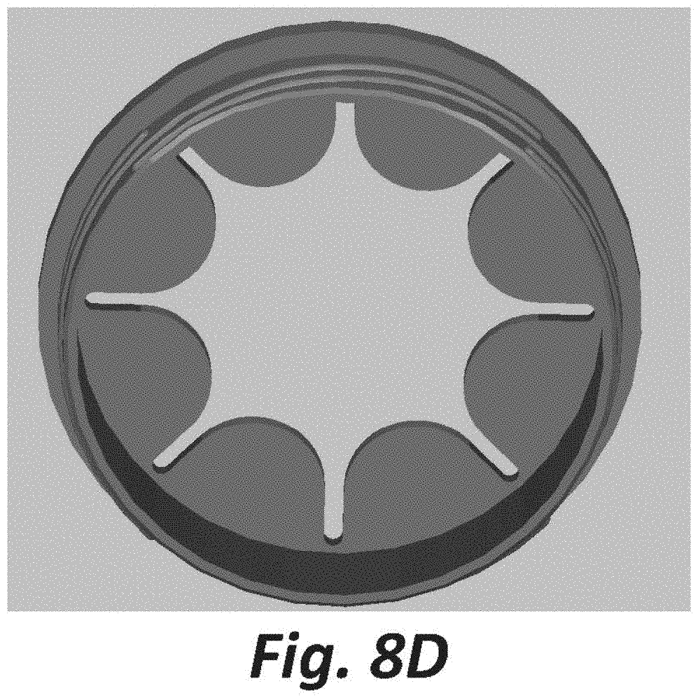

FIGS. 8A-8D illustrates example top lids 28 hat may be removably attached to the waste containment device container 10 of FIGS. 7A-7D. The top lids 28 may have external threads for engaging the internal thread on the top of the device container 10 described above in reference to FIGS. 7A-7D. It should be appreciated that the flowers shape of the opening 32 illustrated in FIGS. 8A-8D are only given by way of example. Other shapes that reduce the size of the opening through the top lid in FIGS. 8A-8D are also contemplated herein.

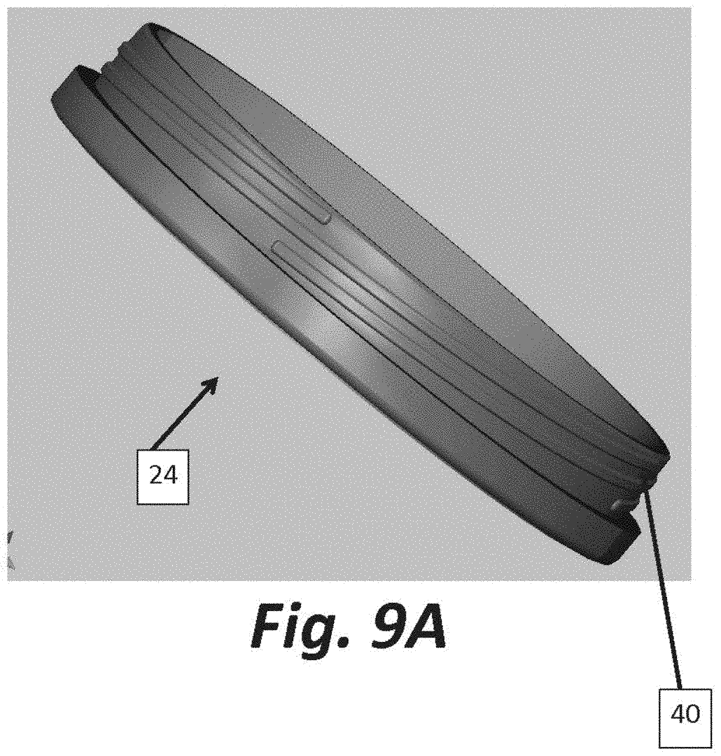

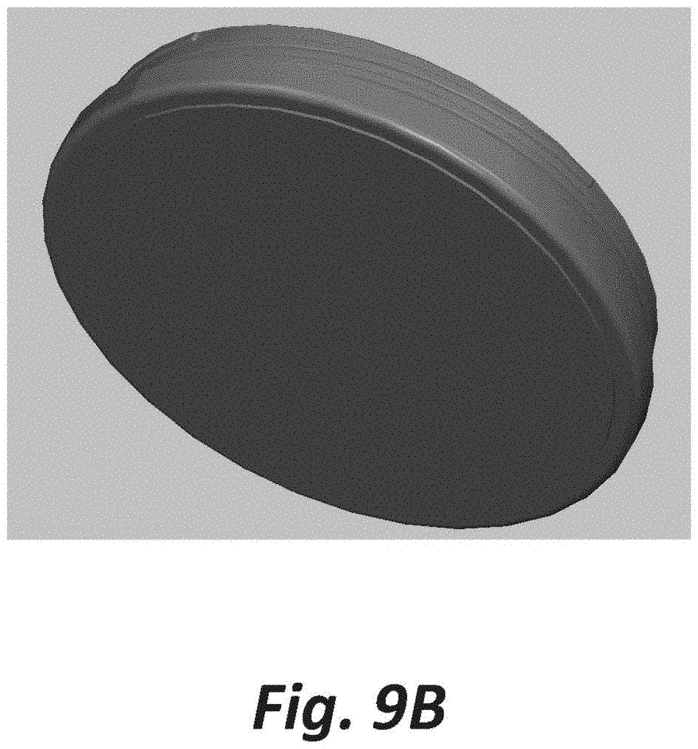

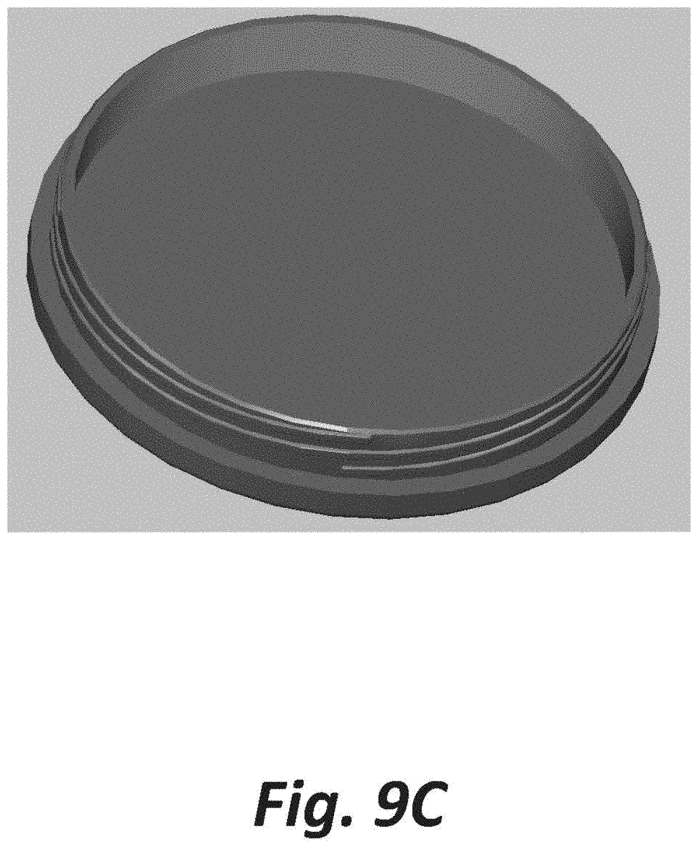

FIG. 9A-9C illustrates example bottom caps 24 that may be removably attached to the bottom of the waste containment device 10 container of FIGS. 7A-7D. The bottom cap 24 may have external threads 40 for engaging the internal thread on the bottom of the device container 10 described above in reference to FIGS. 7A-7D. The bottom cap 24 may enclose the bottom of the device 10, for retaining waste in the device.

In one specific example, the container 10 is made of plastic by blow molding process. The container 10 has a top lid 28. The top lid 28 may be a 60 mm (2⅜″) diameter grommet. These are commonly available from many suppliers in multiple colors (black, white, brown, grey, almond, beige, silver metallic, and custom colors) and are very inexpensive. The grommet 28 as illustrated at least in FIGS. 1A-1B and 1E-1F, has flexible flaps 42 so that waste wrappers can be easily inserted, help retain the small waste in the container, and not allow the small waste to blow out of the container due to wind. The container has an internal diameter such that the grommet will fit tightly with a friction fit. The container 10 has a bottom lid 24. By way of example, and not intended to be a limitation, the tabletop version (FIGS. 1A-1D) of the bottom lid 24 may be a 100 mm (4″) diameter×400 thread (e.g., the lid takes 1 full turn to engage or disengage) unlined bottle lid. For the vehicle cupholder version (FIGS. 1E-1F), the bottom lid 24 may be a 70 mm (2¾″) diameter×400 thread (e.g., the lid takes 1 full turn to engage or disengage) unlined bottle lid.

It should be appreciated that various other shapes and dimensions and features of the container, lid, and bottom portions are contemplated herein. For example, in some aspects, the lid and/or bottom may slip onto the container body without screw threads (e.g., may fit snuggly, may be flanged, or include some type of gasket device, etc.). In some cases, the lid opening may take various different shapes and sizes. For example, in some implementations, the opening may bigger or smaller to accommodate different types of waste for different applications, locations, etc.

While various aspects of the present disclosure have been illustrated and described, as noted above, many changes can be made without departing from the spirit and scope of the disclosure. Accordingly, the scope of the disclosure is not limited by the disclosure of the above examples.

The embodiments of the invention in which an exclusive property or privilege is claimed are defined as follows:

1. A waste containment device comprising,
a chamber, the chamber comprising a generally cylindrical shape and having a first and a second opening at opposite distal ends of the generally cylindrical chamber;
a first lid, the first lid configured to be removably disposed at the first distal end of the chamber, and wherein the first lid includes a top portion which covers the first distal end and wherein the top portion includes a plurality of slits emanating from the center of the top portion toward the outer edge of the upper portion, the slits allowing access through the first lid via the upper portion into an inner portion of the chamber;
a second lid, the second lid configured to be removably disposed at the second distal end.
